(19) United States
(12) Patent Application Publication
(10) Pub. No.: US 2001/0037244 A1
(43) Pub. Date: Nov. 1, 2001

(54) System and a method for providing real-time restaurant reviews

(76) Inventor: Brian M. Mattson, Chicago, IL (US)

Correspondence Address: PATENTS+TMS, A Professional Corporation, 1914 North Milwaukee Avenue, Chicago, IL, 60647, US

(21) Appl. No.: 09/894,266

(22) Filed: Jun. 29, 2001

Related U.S. Application Data
(62) Division of application No. 09/560,067, filed on Apr. 27, 2000.

(51) Int. Cl. G06F 17/60

(52) U.S. Cl. 705/15

(57) ABSTRACT

A system and a method for providing real-time restaurant reviews are provided as well as a restaurant having the capability to provide real-time reviews. The system and method for providing real-time restaurant reviews provide an apparatus for inputting information regarding the quality of the restaurant or other like information relating to the restaurant. The information input by the patron may then be displayed on a network, such as, for example, a computer network like the internet, whereupon other potential restaurant patrons may view the information immediately upon the posting of the information. Other potential patrons may use the information to decide whether they wish to patronize the particular restaurant. Further, a plurality of reviews may be compiled so that a potential patron may receive different viewpoints concerning various features of the restaurant.

This application is a divisional application of U.S. patent application Ser. No. 09/560,067 filed on Apr. 27, 2000.

### BACKGROUND OF THE INVENTION

The present invention generally relates to a system and a method for providing real-time restaurant reviews. More specifically, the present invention relates to a system and a method for providing real-time reviewing of a restaurant within a restaurant by, for example, a patron of the restaurant who may input information into an apparatus to provide individuals outside of the restaurant with real-time information about the restaurant. The present invention further relates to a restaurant having capabilities of providing real-time reviews of the restaurant to individuals outside of the restaurant.

It is, of course, generally known to provide restaurant reviews that are read by many individuals prior to selection of a restaurant. Typically, restaurant reviews are printed in newspapers, magazines or other publications, or verbally expressed on, for example, radio or television. Further, it is generally known to provide restaurant reviews over a computer network, such as, for example, the internet.

These restaurant reviews, however, are generally provided and available after the dining experience. In other words, a reviewer often dines at a restaurant and a review of the restaurant may appear in print form days, sometimes weeks, after the reviewer has patronized the establishment. The review may be fairly current at the time the review is printed; however, often reviews are relied upon by individuals weeks, months, and even years after the review was made. In some cases, crucial members of the staff, such as the chef, may no longer even be associated with the restaurant.

Providing restaurant reviews after the fact does not provide a potential patron information that may be useful, accurate and necessary to the potential patron. Moreover, other information, such as, for example, the size of the crowd in the restaurant at that time, the length of the wait, the quality of the service, the specials of the day, and any other like information that may change on a daily, or even moment-by-moment basis, is never available from a restaurant review.

Further, most restaurant reviews are done by professional and/or paid critics. Such critics may not have tastes and/or criticisms like those of an “average patron” from which many individuals may wish to obtain a review rather than a professional critic. Further, the published restaurant review is merely one opinion from one of many people who may patronize an establishment.

A need, therefore, exists for an improved system and method for providing real-time restaurant reviews that overcome the problems associated with known restaurant review systems and methods as well as a restaurant that accommodates a capability for providing such reviews.

### SUMMARY OF THE INVENTION

The present invention provides a system and a method for providing real-time restaurant reviews. In addition, the present invention relates to a system and a method for providing real-time restaurant reviews on a computer network, such as, for example, the internet. The real-time restaurant review may be accessed by an individual in real-time to provide information to a potential patron about the restaurant. The present invention further relates a restaurant having a capability to provide real-time reviews.

To this end, in an embodiment of the present invention, a system is provided for transmitting real-time information regarding a restaurant. The system has an apparatus having a transmission means in the restaurant for transmitting information regarding the restaurant. A display means displays the information regarding the restaurant.

In an embodiment, a network is provided for receiving and storing the information.

In an embodiment, the network is the Internet.

In an embodiment, the system has a network that displays the first information simultaneously as the information is input into the processing unit.

In an embodiment, a receiving means is provided for receiving the information transmitted by apparatus in the restaurant.

In an embodiment, input means is provided for inputting the information into the apparatus.

In an embodiment, the capacity of posting the information on the Internet website is provided.

In an embodiment, a wireless transmission means is provided.

In another embodiment of the present invention, a method of transmitting information regarding a restaurant is provided. The method comprises the steps of: providing a first apparatus having a transmission means in the restaurant for transmitting information regarding the restaurant; inputting the information into the apparatus regarding the restaurant; and transmitting the information.

In an embodiment, the method further comprises the step of: transmitting the information regarding the restaurant to a display means to be viewed by a person outside of the restaurant.

In an embodiment, the method further comprises the step of: providing a network wherein the information is received and stored; and retrieving the information from the network.

In an embodiment, the method further comprises the step of: providing a computer network; and transmitting the information to the computer network.

In an embodiment, the method further comprises the step of: providing a website on the computer network; and posting the information on the website.

In an embodiment, the method further comprises the step of: accessing the information via a computer.

In another embodiment of the present invention, a restaurant for providing real-time reviews to potential patrons is provided. The restaurant has an apparatus having input means and processing means wherein a patron enters information with the input means. Transmission means associated with the processing means provides for transferring the information to one or more of the patrons.

In an embodiment, the restaurant has a plurality of apparatuses, each having a processing means and an input means and commonly networked to each other.

In an embodiment, the information relates to the restaurant.

In an embodiment, the restaurant for providing real-time reviews to potential patrons further comprises: the transmission means is a radio frequency antenna.

In an embodiment, the transmission means is a connecting wire having access to a network.

In an embodiment, the restaurant has at least one table and the apparatus is provided on the table.

It is, therefore, an advantage of the present invention to provide a system and a method for providing real-time reviews of restaurants or other establishments as well as a restaurant capable of accommodating the same.

Another advantage of the present invention is to provide a system and a method for providing real-time reviews of restaurants that provide information concerning the restaurant that is useful to a potential patron of the restaurant as well as a restaurant capable of accommodating the same.

A further advantage of the present invention is to provide a system and a method for providing real-time reviews of restaurants for reviewing food, ambience, service, recommended foods, specials and any other like information as well as a restaurant capable of accommodating the same.

A still further advantage of the present invention is to provide a system and a method for providing real-time reviews of restaurants that allow potential patrons to access comments and reviews of individuals who are dining or have dined at a restaurant as well as a restaurant capable of accommodating the same.

Moreover, an advantage of the present invention is to provide a system and a method for providing real-time reviews of restaurants that allow access to the comments a patron or a plurality of patrons at a restaurant as well as a restaurant capable of accommodating the same.

A still further advantage of the present invention is to provide a system and a method for providing real-time reviews of restaurants that allow access to comments of restaurant patrons on a portable device such as, for example, a telephone or portable Internet device, as well as a restaurant capable of accommodating the same.

And, another advantage of the present invention is to provide a system and a method for providing real-time reviews of restaurants that provide an apparatus to a restaurant reviewer in the restaurant to write a real-time restaurant review as well as a restaurant capable of accommodating the same.

Yet another advantage of the present invention is to provide a system and a method for providing real-time reviews of restaurants that allow an individual to link the apparatus to the Internet to post his or her real-time review of the restaurant as well as a restaurant capable of accommodating the same.

Additional features and advantages of the present invention are described in, and will be apparent from, the detailed description of the presently preferred embodiments and from the drawings.

### BRIEF DESCRIPTION OF THE DRAWINGS

FIG. 1 illustrates a perspective view of an area of a restaurant and an apparatus for providing a real-time review of a restaurant in an embodiment of the present invention.

FIG. 2 illustrates a black box diagram of an embodiment of a system for providing real-time restaurant reviews.

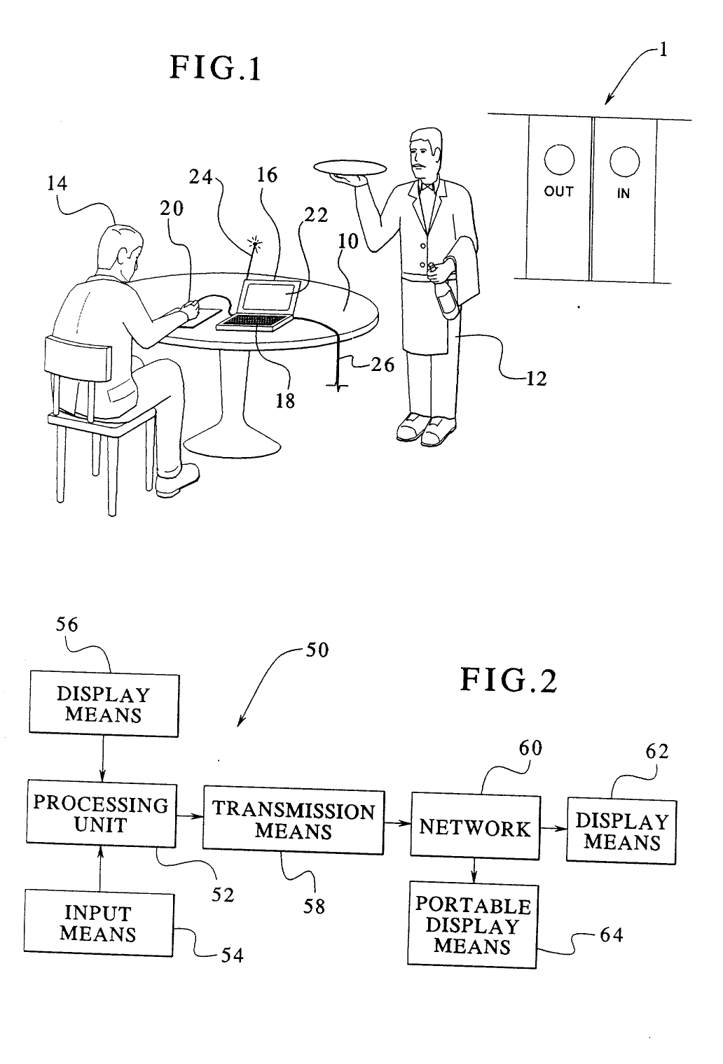

### DETAILED DESCRIPTION OF THE PRESENTLY PREFERRED EMBODIMENTS

The present invention generally relates to a system and a method for providing a real-time review of a restaurant. In addition, the present invention provides a system and a method for providing reviews of restaurants and for providing this information to potential patrons outside the restaurant in real-time. Still further, the present invention relates to a restaurant having a capability for providing real-time reviews to potential patrons outside the restaurant.

Referring now to the drawings wherein like numerals refer to like parts, an interior area 1 of a restaurant is generally illustrated. The area 1 of the restaurant may include a table 10, a server 12 and any other items or individuals that may generally be found in a restaurant and that may be apparent to those skilled in the art. Further, the restaurant may be an eating establishment and/or a bar, or any other establishment that may provide food or drinks.

At the table 10 may be a restaurant patron 14. The restaurant patron 14 may be utilizing the services of the restaurant, such as, for example, having a meal and/or enjoying a drink or otherwise using the restaurant in any way that may be apparent to those skilled in the art.

Contained on the table 10 may be an apparatus 16 that may allow the patron 14 to provide information about the restaurant to a computer network, such as, for example, the internet. The apparatus 16 may contain a processing unit 52 (as shown in FIG. 2), a keyboard 18 and/or a mouse 20 or other like device for entering information into the processing unit 52. Further, the apparatus 16 may include a display 22 that may provide information to the patron 14. This information may include a standard form or other like interface that may allow the patron 14 to enter information into the apparatus 16. Further, the display 22 may be a touch-screen whereupon the patron 14 may input information into the apparatus 16 by merely touching specific areas on the touch-screen using an electronic pen, his or her finger, or other like means apparent to those skilled in the art.

Alternatively, the apparatus 16 may be a portable device that lets a restaurant patron input a restaurant review thereinto to post in real-time on a computer network. The apparatus 16 may .be, for example, a cellular phone having access to the Internet or may be any other like device apparent to those skilled in the art. For example, a Timeport Webphone™ manufactured by Motorola or a Palm Pilot™ organizer manufactured by 3Com, Inc. may be used.

The apparatus 16 may include a transmission means such as an antenna 24 and/or a connecting wire 26. The antenna 24 and/or the connecting wire 26 may provide a connection to a computer network such as, for example, the Internet, so that the patron 14 may post his or her review of the restaurant.

The patron 14 may provide information concerning the particular restaurant that the patron 14 is experiencing to provide real-time information about the restaurant as the patron 14 is using the restaurant. The patron 14 may review the food, such as the quality thereof, the selection, the type and/or any other quality that may be apparent to those skilled in the art. Further, the patron 14 may review the ambience, the size of the crowd, the length of the wait for a table, the service, recommended foods, bad foods, and/or specials of the day or any other like information. Further, any other quality of the restaurant may be reviewed as may be apparent to those skilled in the art; this invention should not be limited as to the particular qualities as specified above.

Providing review information in real-time may allow a potential patron the ability to determine specific characteristics of a plurality of restaurants to determine which restaurant the potential patron may wish to patronize. Further, the potential patron may receive a plurality of reviews from a plurality of restaurant patrons that are in the same restaurant to obtain a survey of the restaurant from a plurality of points of view. The potential patron may also activate an instant messaging capability to direct specific questions to the patron 14 of the restaurant. The instant message may be random and received by any patron within the restaurant.

Referring now to FIG. 2, a black box diagram of a system 50 is provided. The system 50 may have a processing unit 52, an input means 54, a display means 56 and a transmission means 58. The patron 14 may use the input means 54 to input specific information about the restaurant into the processing unit 52. The patron 14 may use the display means 56 to review what the patron 14 inputs into the processing unit 52. After the patron 14 has input information concerning the particular restaurant 1 into the processing unit 52 via the input means 54, the patron 14 may send the information via the transmission means 58 to a network 60. The network 60 may be any type of information network, such as, for example, the Internet.

Connected to the network 60 may be a display means 62 such as, for example, a computer display monitor or any other like display means capable of displaying information thereon. A user may use the display means 62 to view the information posted on the network 60 by the patron 14. This may be accomplished as the patron 14 is utilizing the particular restaurant. The user may then receive real-time information about the conditions of the restaurant. The user may then decide whether he wishes to patronize that restaurant or may use the information for any reason that may be apparent to those skilled in the art.

Further, a portable display means 64 may be connected to the network 60 via a portable connecting wire or a radio transmission means via an antenna. For example, the portable display means may be a telephone having a screen thereon whereupon the user may show information posted by the patron 14 in the restaurant.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for transmitting information regarding a restaurant, the system comprising:
an apparatus having a transmission means in the restaurant for transmitting information regarding the restaurant; and
a display means for displaying the information regarding the restaurant.

2. The system of claim 1 wherein the transmission of information is in real-time.

3. The system of claim 1 or 2 further comprising:
a network for receiving and storing the information.

4. The system of claim 3 wherein the network is the Internet.

5. The system of claim 1 or 2 wherein the first information is displayed on the display means simultaneously as the information is input into the processing unit.

6. The system of claim 1 or 2 further comprising:
a receiving means for receiving the information transmitted by the apparatus in the restaurant.

7. The system of claim 1 or 2 further comprising:
an input means for inputting the information into the apparatus.

8. The system of claim 1 or 2 wherein the information is posted on an Internet website.

9. The system of claim 1 or 2 wherein the transmission means is wireless.

10. The system of claim 1 wherein the transmission means is by way of synchronization of systems.
